(19) United States
(12) Patent Application Publication
(10) Pub. No.: US 2007/0116218 A1
(43) Pub. Date: May 24, 2007

(54) Preventing connections from calling terminals

(75) Inventors: John Storrie, Maidenhead (GB); Christopher Swindle, Reading (GB); Paul Kettlewell, Aylesbury (GB)

Correspondence Address: BARNES & THORNBURG LLP, P.O. BOX 2786, CHICAGO, IL, 60690-2786, US

(73) Assignee: Nortel Networks Limited

(21) Appl. No.: 11/252,931

(22) Filed: Oct. 18, 2005

(51) Int. Cl. H04M 15/06; H04L 12/58

(52) U.S. Cl. 379/142.01; 455/412.1

(57) ABSTRACT

The present invention is designed to prevent nuisance calls to a user from calling parties, especially when the number of the calling party is withheld. A database is compiled of calling parties who the user does not wish to receive communications from and calls from those parties are blocked. The identity of the calling party is added to the database after the user receives a call from the party and decides at the time of the call that they do not wish to receive any further communication from that party. They invoke a method which extracts the identity of the calling party from the call signalling messages and adds it to the database. In this way further communications from the party will be denied.

### FIELD OF THE INVENTION

This invention relates to a method of selectively preventing connections being made between calling and receiving terminals. The invention is particularly applicable for use in instances when a user at a receiving terminal does not wish to receive any further communication from a calling terminal but the user at the calling terminal opted to deny the receiving terminal access to their identity.

### BACKGROUND OF THE INVENTION

The technique of cold calling a person, for example to sell goods or conduct market research, is well known. Many people do not wish to receive calls from such people and would like to bar calls from them. One way that a user can do this is to inform their service provider that they no longer wish to receive calls from a certain telephone number. However, in this case the user must know the number that they wish to block and, therefore, if the calling party prevents their number from being accessible to person receiving the call then the receiving party cannot prevent further calls made from that number.

One possible solution to this problem is for a user to configure their terminal such that any call connection requests in which the calling terminal's user has prevented access to the identity of their terminal are denied. However, often, as a safety precaution, users choose not to allow the identity of their terminal to be displayed at the terminal to which they are requesting a connection. Furthermore, the calling terminal may be permanently configured to prevent access to its address information. If this is the case then it is very possible that although the calling party is someone to whom the receiving party wishes to talk the call connection is still denied.

### SUMMARY OF THE INVENTION

According to a first aspect of the invention there is provided apparatus comprising a request receiver arranged to receive a request message requesting not to receive calls from a calling party of incoming call signalling, the incoming call signalling being for setting up a call to a receiving terminal, an identity extractor arranged to extract the identity of a calling terminal from the incoming call signalling in response to the request and an inserter arranged to insert the identity of the calling party into a database for storing identities of calling terminals which should be denied a connection to the receiving terminal.

Preferably there is also provided comparator arranged to compare identities stored in the database with the identity of the calling terminal and denying a connection if the calling terminal's identity is present in the database. This means that if a receiving terminal requests a calling terminal's identity to be added to the database any further call connection requests from the calling terminal are denied. The advantage of this is that if the calling terminal is arranged to prevent its identity from being accessed by the receiving terminal then the call connection request can be denied according to whether the receiving terminal has specified that they wish the call connection not to be allowed.

Preferably, when the connection to the receiving terminal is denied the calling terminal is connected to a device adapted to play an announcement to a user at the calling terminal. This will prevent further calls from being made from the calling terminal to the receiving terminal. It will also alert any users whose terminals have been mistakenly added to the database and therefore denied connection to the receiving terminal that this mistake has occurred. This allows a calling terminal user to contact the receiving terminal user in order that the receiving terminal user can act to remove the number from the database.

Preferably, access to at least part of the database by the user of the receiving terminal is denied. This is because in order to comply with regulations when a calling terminal is configured to deny access by a receiving terminal to its identity the serviced provider cannot allow the user of the receiving terminal to access the identity even after the call is terminated.

According to a second aspect of the invention there is provided a method for preventing call connections from a calling party to a receiving party comprising the steps of receiving a request message from the receiving party requesting not to receive calls from a calling party of incoming call signalling, the incoming call signalling being for setting up a call to the receiving terminal in response to the request, extracting the identity of the calling party from the request for connection; and inserting the identity of the calling party into a database for storing identities of calling terminals which should be denied a connection to the receiving terminal. In this way the identities of calling parties can be entered into the database even if the user at the receiving terminal is denied access to the calling party's identity.

Preferably, the identity of a calling party is compared with identities stored on the database and a call connection with the receiving party is denied if the identity of the calling party is present on the database.

According to a third aspect of the invention there is provided a an incoming call signalling receiver arranged to receive incoming call signalling, the incoming call signalling being for setting up a call to the terminal and a user input arranged to receive an input from a user of the terminal not to receive calls from a calling party of an incoming call signalling.

Preferable the terminal is also includes a signalling output arranged to transmit a request message not to receive calls from the calling party. In order that further calls from the calling party are denied a call connection. Preferably, the terminal is able to transmit the request even when the identity of the terminal sending the incoming call signalling is not accessible by the user of the terminal.

Preferably the terminal extracts the identity of the calling party from the incoming call signalling. Preferably the user input is one of entering a code into the receiving terminal, pressing a dedicated key on the receiving terminal or selecting a button on a screen of the receiving terminal.

According to a fourth aspect of the invention there is provided a method for preventing call connections from a calling party to a receiving party comprising the steps of the calling terminal receiving incoming call signalling, the incoming call signalling, being for setting up a call to the terminal and the calling terminal receiving an input from a user of the terminal not to receive calls from a calling party of an incoming call signalling.

### BRIEF DESCRIPTION OF THE DRAWINGS

FIG. 1 illustrates a network in which the present invention may be implemented; and

FIG. 2 illustrates the method of the present invention.

### DETAILED DESCRIPTION OF PREFERRED EMBODIMENTS

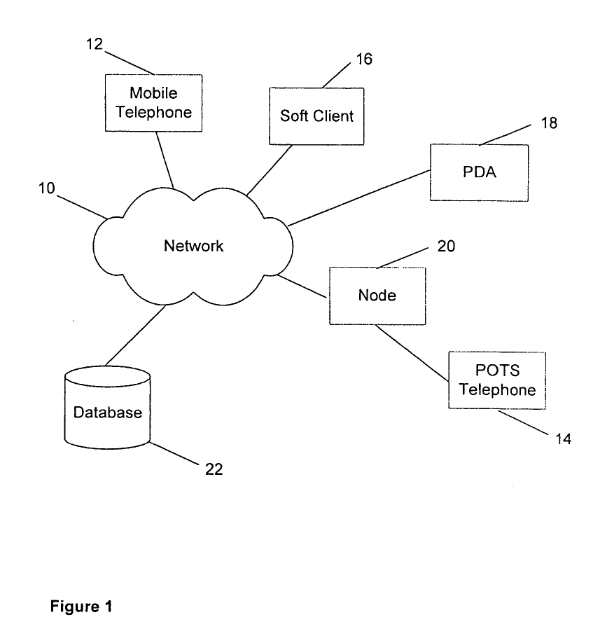

FIG. 1 shows a network 10 having a number of terminals including, for example, a mobile terminal 12, POTS terminal 14, a soft client, such as a personal computer, 16 and a PDA 18. The terminals may be calling terminals if they are requesting a connection with another terminal. Alternatively, if the terminal is receiving the call connection request then it is a receiving terminal.

The network 10 also has a node 20 that is responsible for routing calls to the terminals. There may be more than one node present in the network 10 and not all terminals in the network 10 are necessarily connected to the same nodes 20. The node 20 may be a telephone exchange server. Alternatively it may be located within the telephone operator's central office or exchange. It may also be a routing node present in a data communications network or any other suitable platform.

Also present in the network 10 is a database 22. The database 22 contains a personalised list of all the identities of calling terminals from which a receiving terminal does not wish to receive communications. The database may be stored on a separate server, at the node 20 or at any other suitable point in the network. Additionally, the database may also contain personalised lists for multiple receiving terminals.

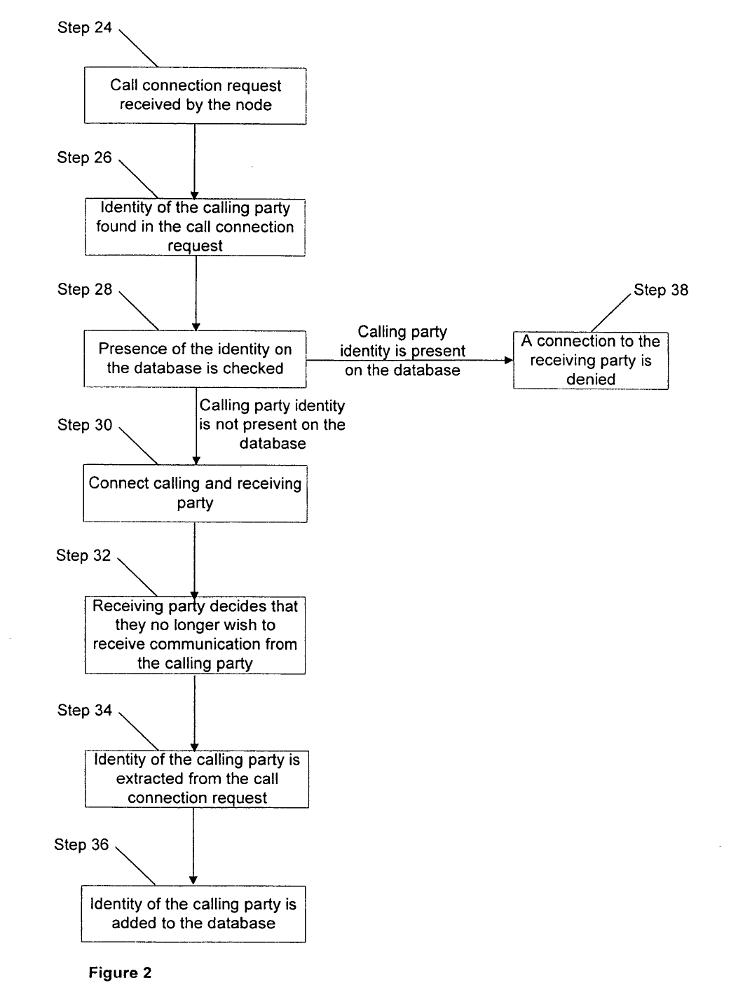

When a call is made by a user at a calling terminal to a receiving terminal the call connection request and other associated messages used to set up a call connection includes the identity of the calling terminal. When a calling terminal makes a call connection request, as shown in Step 24 of FIG. 2, the identity of the calling terminal is determined from the call connection request (or any other suitable message) (Step 26) and the identity is then checked against the database (Step 28).

If the identity of the calling terminal is not present in the database then the call connection is allowed and the calling terminal is connected to the receiving terminal (Step 30).

If, on connection the user at the receiving terminal decides that they do not wish to receive any further communication from that number, if for example, the calling terminal user is a marketing company, then the user may cause the receiving terminal to send a signal to the node (Step 32). The signal may be generated by entering a specific code into the receiving terminal. Alternatively the signal may be generated using a dedicated interface, for example by, pressing a dedicated button on the receiving terminal, selecting a dedicated button on the screen of a receiving computer or by any other suitable means.

When the node receives the signal it then extracts the identity of the calling terminal as shown in Step 34. The identity of the calling terminal may be, for example, a POTS number or SIP address. The calling terminal's identity is then sent to the database where it is added to the receiving terminal's personalised database (Step 36).

Alternatively, when the signal is sent to the node the call connection request may be re-sent to a processor connected to the database. The processor being enabled to extract the calling terminal's identity and insert the identity into the database.

In this way the next incoming call from the calling terminal will be blocked and no further connection to the receiving terminal will be allowed as discussed below.

If the user at a receiving terminal has added a calling terminal's identity to the database then any further connection requests for the receiving terminal from the calling terminal will be denied (see Step 38). Preferably, when a connection to the receiving terminal is denied because the calling terminal's identity is present on the database the calling terminal is connected to an announcement device. Once connected to the announcement device the user at the calling terminal is informed that a connection is denied because the receiving terminal's user does not wish to receive further communications from them.

The present invention is advantageous as it allows a user at a receiving terminal to selectively prevent calls from users at calling terminals that deny a receiving terminal user access to their identities. Connections from users who deny the receiving terminal user access to their identity but with whom the receiving terminal user still wants to communicate are still allowed.

Although regulations prevent a receiving terminal user from viewing the identity of the calling party the database may be made secure and connections to the receiving terminal from calling terminals on the database can be prevented without the user at the receiving terminal needing to know the calling terminal's identity.

Alternatively, if desired the database may have two separate sections. The first section may be available to the receiving terminal's user for them to study. The identities of calling terminals whose users have not prevented access to their identity by the receiving terminal's users may be stored in this section of the database. In the second section identities of terminals whose users have opted to deny the receiving terminal's user access to their identity are stored.

In order to remove a calling terminal's identity from a secure section of the database or the entire database, if the receiving party is denied access to the entire database the receiving terminal's user must contact the service provider.

The database may be used to prevent a calling party from connecting to more than one terminal if the user has more than one receiving terminal such as a mobile telephone and a POTs telephone.

What is claimed is:

1. Apparatus comprising:
(a) a receiver arranged to receive a request message requesting denial of call connections from a calling party;
(b) an extractor arranged to extract the calling party's identity in response to the request; and
(c) an inserter arranged to insert the identity of the calling party into a database for storing identities of calling parties which should be denied a call connection to the receiving terminal.

2. The apparatus as claimed in claim 1 further comprising a processor arranged to compare identities stored in the database with the identity of the calling terminal and denying a call connection if the calling terminal's identity is present in the database.

3. The apparatus as claimed in claim 1 further comprising a device adapted to play an announcement to a user whose calling terminal has been denied a call connection.

4. The apparatus as claimed in claim 1 wherein access to at least part of the database by the receiving terminal's user is prevented.

5. The apparatus as claimed in claim 1 wherein the identity of the calling party is extracted from incoming call signalling.

6. The apparatus as claimed in claim 1 wherein the identity of the calling party is extracted from the request message.

7. The apparatus as claimed in claim 1 wherein the party transmitting the request message is prevented from accessing the identity of the calling party.

8. A method for preventing call connections from a calling party to a receiving party comprising the steps of:
(a) receiving a request message from the receiving party requesting denial of call connections from a calling party;
(b) extracting the identity of the calling party in response to the request; and
(c) inserting the identity of the calling party into a database for storing identities of calling terminals which should be denied a call connection to the receiving terminal.

9. A method for preventing call connections as claimed in claim 8 wherein the receiving terminal is denied access to the identity of the calling party.

10. A method for preventing call connections as claimed in claim 8 comprising the further step of comparing the identity of a calling party with identities stored on the database and preventing call connection with the receiving party if the identity of the calling party is present on the database.

11. A terminal comprising:
(a) a dedicated user interface that, when activated, requests transmission of a request message requesting denial of call connections from a party to which the terminal is connected; and
(b) an output arranged to transmit the request message.

12. A terminal as claimed in claim 11 wherein the call connection request prevents the identity of the terminal transmitting the call connection request from being displayed.

13. A terminal as claimed in claim 11 wherein the terminal extracts the identity of the calling party from the incoming call signalling.

14. A terminal as claimed in claim 11 wherein the input by the user is made by one of the group of: entering a code into the receiving terminal; pressing a dedicated key on the receiving terminal and selecting a button on a screen of the receiving terminal.

15. A method for preventing call connections from a calling terminal to a receiving terminal comprising the receiving terminal receiving an incoming call connection request, and transmitting a request message requesting denial of call connections from the terminal that is making the call connection request, the request message being transmitted in response to an input by a user of the terminal.
